(19) United States
(12) Patent Application Publication
(10) Pub. No.: US 2025/0243369 A1
(43) Pub. Date: Jul. 31, 2025

(54) TREATMENT COMPOSITIONS INCLUDING FUNCTIONALIZED PARTICULATE

(71) Applicant: ChampionX LLC, Sugar Land, TX (US)

(72) Inventors: Jeremy Moloney, Katy, TX (US); Duy Nguyen, Richmond, TX (US)

(21) Appl. No.: 19/034,845

(22) Filed: Jan. 23, 2025

Related U.S. Application Data
(60) Provisional application No. 63/624,850, filed on Jan. 25, 2024.

(51) Int. Cl. C09D 5/08; C09D 7/20; C09D 7/40; C09D 7/62; C09D 7/63

(52) U.S. Cl. CPC C09D 5/086; C09D 7/20; C09D 7/62; C09D 7/63; C09D 7/68

(57) ABSTRACT

Treatment compositions include a mixture of a corrosion inhibitor and a functionalized particulate in a solvent. The functionalized particulate includes both epoxy and amine groups. Surfaces coated with the treatment composition have improved corrosion inhibition performance, and/or greater duration of corrosion inhibition performance with respect to corrodents such as CO₂ and H₂S when compared to the corrosion inhibition performance of the same corrosion inhibitor coating in the absence of the functionalized particulate. The coatings including functionalized particulate are usefully applied to one or more interior and/or exterior surfaces of containments, separators, conduits, and other equipment, such well string completion components, that are contacted by fluids containing corrodents.

### BACKGROUND

Nearly all operators in the hydrocarbon extraction and processing industry employ corrosion inhibitors to reduce internal corrosion in metal containments, conduits, and other equipment components contacted by produced fluids containing corrodents. Corrosion inhibitors are applied to various surfaces in the completion string as well as in processing and refinement equipment, where they act to prevent, retard, delay, reverse, and/or otherwise inhibit the corrosion of metal surfaces, such as carbon-steel surfaces. Such use of corrosion inhibitors is recognized to be highly beneficial for extending equipment lifetime.

However, the ability to provide effective corrosion inhibition treatments to the interior surfaces of hydrocarbon recovery and processing equipment, particularly within the enclosed conduits and containments of a completion string of a producing wellbore, is an ongoing challenge. In one commonly employed method, the interior surfaces of the completion string of a producing wellbore are coated directly with scale inhibition and/or corrosion inhibition treatments using a “pig”. “Pigging” is a general term for the practice of using devices—pigs—to perform various operations within the interior of hydrocarbon recovery and processing equipment, particularly within the enclosed conduits (pipes) of a completion string of a producing wellbore. Thus, for example, a pig can travel inside one or more conduits of a producing wellbore to clean the interior conduit surface (e.g. by scraping and/or chemical deposition) and/or deposit one or more coating materials directly to the interior surface of the conduit as it travels.

Accordingly, pigging is used broadly in the hydrocarbon extraction and processing industry to apply treatment materials as coatings to one or more interior surfaces of hydrocarbon recovery and processing equipment that contact produced water. Pigging is generally considered to be more efficient than common batch treatment for application of corrosion inhibitors, at least because batch treatment requires large volumes of adjuvant water to flush a concentrated bolus of corrosion inhibitor into a producing well, where is carried along with the produced fluids of the well to contact the completion string pipes, containments, etc. in a constantly changing concentration.

Coatings applied by pigging are typically a mixture of one or more treatment materials with a solvent such as toluene, xylene, HAN, methyl isobutyl ketone, and the like. However, even after applying a solvent-based treatment composition, the resulting treatment coatings are constantly degraded, and their efficacy decreased, as fresh corrodent-bearing fluid flows through the equipment, continuously challenging the coated surfaces and reducing the amount of treatment material available to benefit the surfaces by preventing corrosion and/or scale buildup.

Accordingly, there is an ongoing need in the oil and gas extraction industry for improved treatment compositions that result in higher treatment efficacy when applied as a coating on the interior surfaces of the completion string of a producing wellbore.

### SUMMARY

Disclosed herein are treatment compositions for coating a surface in need of corrosion inhibition; methods of treating a surface in need of corrosion inhibition by coating the surface with the treatment compositions; and treated surfaces formed by coating the treatment compositions thereon. In embodiments, the surface in need of corrosion inhibition is an interior surface of a separator, a conduit such as a pipe or a tube, or a containment such as a tank or vat. In embodiments, the separator, conduit, and/or containment is part of a completion string of a producing wellbore. The treated surfaces have improved corrosion inhibition performance when compared to performance of the same corrosion inhibitor applied to the same surface in the same amount, but in the absence of the functionalized particulate.

The treatment compositions comprise, consist essentially of, or consist of a mixture of a corrosion inhibitor and functionalized particulate. In embodiments, the corrosion inhibitor includes one or more amine groups. In embodiments, one or more of the amine groups is a primary amine group. In embodiments, the corrosion inhibitor having an amine group comprises, consists essentially of, or consists of an imidazoline, an amidoamine, a quaternary ammonium compound, an aromatic amine, an amine condensate, or a combination of two or more thereof.

In embodiments the functionalized particulate is a group of discrete particles having an average particle size between 1 nm and 1000 nm, wherein the surface of the particles includes amine groups and epoxy groups. In embodiments, the functionalized particulate is formed by functionalizing the surface of a particulate using one or more silane coupling agents, further wherein the particulate is a group of discrete particles having an average particle size between 1 nm and 1000 nm and comprising, consisting essentially of, or consisting of silica, alumina, zirconia, titania, magnesium oxide, iron oxide, manganese oxide, copper oxide, nickel oxide, or any combination of these. In embodiments, the particulate consists essentially of or consists of silica. In embodiments, the silica particulate comprises, consists essentially of, or consists of a colloidal silica or a fumed silica.

In embodiments, the treatment compositions include 10 wt % to 90 wt % of the corrosion inhibitor. In embodiments, the treatment compositions include 0.1 wt % to 2 wt % of the functionalized particulate. In embodiments, the corrosion inhibitor and the functionalized particulate are present in the treatment composition at a ratio of 1000:1 to 2:1 by weight.

In embodiments, the treatment compositions further include a solvent. In some embodiments, the treatment compositions include 10 wt % to 90 wt % of the solvent. In embodiments, the solvent comprises, consists essentially of, or consists of xylene, benzene, toluene, aromatic naphtha, diesel, kerosene, fuel oil, or a combination of two or more thereof.

In embodiments, the treatment compositions are coating compositions, that is, the treatment compositions are used for coating a surface in need of corrosion inhibition, wherein coating is treating. Accordingly, also disclosed herein are methods of treating a surface, the method comprising, consisting essentially of, or consisting of mixing a corrosion inhibitor, a functionalized particulate, and a solvent to form a treatment composition; and contacting the treatment composition with the surface to form a treated surface. In embodiments, the contacting is carried out in a batch treatment. In embodiments, the batch treatment is dip coating, brush coating, spray coating, or pigging. In embodiments, the pigging is carried out by a smart pig, a spray pig, or a smart spray pig.

Accordingly, also disclosed herein is a treated surface comprising, consisting essentially of, or consisting of a coating disposed on a surface, the coating including, consisting essentially of, or consisting of a mixture of a corrosion inhibitor and a functionalized particulate. In embodiments, the coating is formed by contacting a treatment composition with the surface, wherein the treatment composition comprises, consists essentially of, or consists of a mixture of a corrosion inhibitor, a functionalized particulate, and a solvent.

In embodiments, the coating includes about 90 wt % to 99.9 wt % of the corrosion inhibitor. In embodiments, the coating includes about 0.1 wt % to 10 wt % of the functionalized particulate. In embodiments, the coating comprises, consists essentially of, or consists of about 0.1 wt % to 10 wt % of the functionalized particulate and about 90 wt % to 99.9 wt % of the corrosion inhibitor. In embodiments, the corrosion inhibitor and the functionalized particulate are combined in the coating at a weight ratio of 1000:1 to 2:1. In embodiments, the thickness of the coating is 1 μm to 1 mm. In embodiments, the surface includes metal, glass, plastic, or a combination of two or more thereof. In embodiments, the metal surface is a carbon steel surface, a steel alloy surface, a stainless steel surface, a copper alloy surface, a yellow metal surface, or a combination of two or more thereof. In embodiments, the surface is part of a completion string of a producing wellbore. In embodiments, the surface is a surface of a separator, an interior surface of a conduit such as a pipe or a tube, or an interior surface of a containment such as a tank or vat.

In embodiments, the methods disclosed herein further include contacting a treated surface with one or more corrodents. In embodiments, the methods disclosed herein further include contacting a treated surface with a crude oil, a produced water, or any combination thereof.

Also disclosed herein are uses of functionalized particulates to form corrosion inhibitor treatment compositions. Also disclosed herein are uses of the treatment compositions to form treated surfaces, wherein the treated surfaces have decreased rates of corrosion when compared to the corrosion rates incurred after treating the same surface with the same amount of the same corrosion inhibitor, but in the absence of the functionalized particulate.

### DETAILED DESCRIPTION

Although the present disclosure provides references to preferred embodiments, persons skilled in the art will recognize that changes may be made in form and detail without departing from the spirit and scope of the invention. Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### Definitions

As used herein, “particulate” refers to a discrete group or mass of particles characterized by a particle size of 1 nm-1000 nm.

As used herein, “particle size” refers to an average particle size, a median particle size, a mean particle size, or a particle size dispersity of a particulate, as specified or determined by context and further as such particle sizes are determined by a method of particle size analysis known by those of ordinary skill in the art of analyzing particles having dimensions of 1000 nm or less. Such methods include light scattering analysis and Coulter counter methods, for example. Unless specified otherwise, “particle size” generally refers to a volume-based average or method of measuring a volume-based average, further assuming spherical particles. When comparing two or more particulates, differences in median particle sizes and/or other particle size parameters are determined based on the respective individually determined median particle sizes and/or other specified parameters.

As used herein, the term “solvent” refers to a compound that is water, a compound that is partially or completely miscible with water, a compound that is a liquid at 25° C./1 atm and has a flashpoint of 100° C. or less, or a mixture of two or more thereof. The term “solvent” may refer to a single compound or a mixture of two or more compounds, as determined by context.

As used herein, the terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5”, “about 1 to about 5”, “1 to about 5” and “about 1 to 5” unless specifically limited by context.

As used herein, the word “substantially” modifying, for example, the type or quantity of an ingredient in a composition, a property, a measurable quantity, a method, a position, a value, or a range, employed in describing the embodiments of the disclosure, refers to a variation that does not affect the overall recited composition, property, quantity, method, position, value, or range thereof in a manner that negates an intended composition, property, quantity, method, position, value, or range. Examples of intended properties include, solely by way of non-limiting examples thereof, flexibility, partition coefficient, rate, solubility, temperature, and the like; intended values include thickness, yield, weight, concentration, and the like. The effect on methods that are modified by “substantially” include the effects caused by variations in type or amount of materials used in a process, variability in machine settings, the effects of ambient conditions on a process, and the like wherein the manner or degree of the effect does not negate one or more intended properties or results; and like proximate considerations. Where modified by the term “substantially” the claims appended hereto include equivalents to these types and amounts of materials.

### Discussion

The compositions described herein comprise, consist essentially of, or consist of a mixture of a corrosion inhibitor, or “CI”, with a functionalized particulate.

In embodiments, the CI is an organic amine, or a mixture of two or more organic amines. In some embodiments, the CI includes a single amine group; in other embodiments, the CI includes two or more amine groups. In embodiments, the CI includes 3, 4, 5, 6, 7, 8, 9, or 10 amine groups. In embodiments the CI includes one or more primary amine moieties. In embodiments the CI includes one or more secondary amine moieties. In embodiments the CI includes one or more primary amine moieties, and one or more secondary amine moieties.

In embodiments, the CI comprises, consists essentially of, or consists of an imidazoline, an amidoamine, a quaternary ammonium compound, an aromatic amine, an amine condensate, or a combination of two or more thereof.

In embodiments, the CI includes, consists essentially of, or consists of an amine condensate. The amine condensate is a reaction product of an organic compound having at least two amine groups, and often at least two primary amine groups, with an organic acid. In embodiments, the amine is ethylene diamine, diethylene triamine, triethylenetetramine, tetraethylenepentamine, N-(2-aminoethyl)-1,2-ethanediamine, or a combination of two or more thereof. In embodiments, the amine condensate is a reaction product of a diamine, triamine, or higher amine, with a fatty acid. In embodiments, the fatty acid is a saturated fatty acid, a monounsaturated fatty acid, a polyunsaturated fatty acid, or a combination of two or more thereof. In embodiments the fatty acid comprises, consists essentially of, or consists of tall oil fatty acid, naphthenic acid, lauric acid, myristic acid, palmitic acid, palmitoleic acid, stearic acid, oleic acid, linoleic acid, arachidonic acid, or a combination of two or more thereof. In embodiments, the amine condensate is a reaction product of diethylene triamine with tall oil fatty acid. In embodiments, the amine condensate is a reaction product of diethylene triamine with oleic acid.

In embodiments, the amine condensate includes, consists essentially of, or consists of an imidazoline. The term “imidazoline” refers to one or more members of the class of heterocycles derived from imidazoles by the reduction of one of the two double bonds. Unless specified otherwise, an imidazoline is a 2-imidazoline, a 3-imidazoline, a 4-imidazoline, or a mixture of two or more thereof. In embodiments, the imidazoline is a 2-imidazoline. In embodiments, the imidazoline has structure 1,

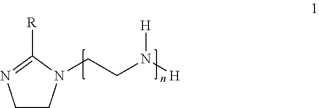

wherein R is a linear or branched alkyl, alkenyl, alkaryl, or aryl group having 12 to 30 carbons and n is an integer between 1 and 5. In embodiments, n is 1 and the imidazoline has structure 1a,

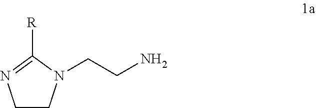

In embodiments, the amine condensate includes, consists essentially of, or consists of an amidoamine, a linear amine-functional amide. In embodiments, the amidoamine has structure 2,

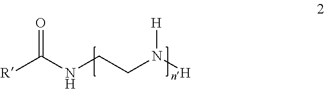

wherein R′ is a linear or branched alkyl, alkenyl, alkaryl, or aryl group having 12 to 30 carbons and n′ is an integer between 1 and 5. In embodiments, R′ is the same or substantially the same as R of structure 1. In embodiments, n′ is the same or substantially the same as n of structure 1. In embodiments, n′ is 1 and the amidoamine has structure 2a.

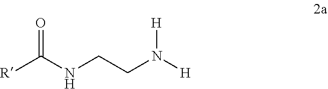

In embodiments, the CI comprises, consists essentially of, or consists of a mixture of an imidazoline and an amidoamine. In embodiments, the CI comprises, consists essentially of, or consists of a mixture of compounds of structure 1 and structure 2. In embodiments, the CI comprises, consists essentially of, or consists of a mixture of compounds of structure 1a and structure 2a.

In embodiments, the CI comprises, consists essentially of, or consists of a quaternary ammonium compound. In embodiments, the quaternary ammonium compound comprises, consists essentially of, or consists of a C10-C20 alkyl dimethyl benzyl ammonium chloride, dodecyl didecyl dimethyl ammonium chloride, hexadecyltrimethylammonium chloride, benzalkonium chloride, or a combination of two or more thereof. In embodiments, the quaternary ammonium compound comprises, consists essentially of, or consists of a C12-C18 alkyl dimethyl benzyl ammonium chloride.

In embodiments, the CI comprises, consists essentially of, or consists of an aromatic amine. In embodiments, the aromatic amine comprise, consists essentially of, or consists of a pyrimidine, a pyridine, a quinoline, a purine, an acridine, an amino-functionalized pyrimidine, a carboxyl-functionalized pyrimidine, a conjugate base of a carboxyl-functionalized pyrimidine; and combinations of two or more thereof.

In embodiments, the CI is a mixture of two or more different CIs, that is, two or more CIs having different chemical compositions, different molecular weights, different numbers of amine groups per molecule, or another mixture of two or more different CIs. Such mixtures of CIs includes mixtures of any two or more of the foregoing CIs listed herein. In such embodiments, the two or more different CIs are present in a treatment composition in any ratio therein, and the total amount of CI amine in the treatment compositions is between 10 wt % and 80 wt % based on the weight of the treatment compositions.

As noted above, the compositions described herein comprise, consist essentially of, or consist of a mixture of the CI with a functionalized particulate. In embodiments, the functionalized particulate is a discrete group of particles having a particle size of 1 nm to 1000 nm, further wherein the surface of the particles comprises amine groups and epoxy groups. In embodiments the functionalized particulate consists of or consists essentially of a source particulate having epoxy groups and amine groups covalently bonded to the surface thereof. In embodiments, the source particulate comprises, consists essentially of, or consists of a metal oxide selected from silica, alumina, zirconia, zinc oxide, titanium dioxide, magnesium oxide, iron oxide, manganese oxide, copper oxide, nickel oxide, or any combination of these. In embodiments, the source particulate is suitably characterized as one or more of: mesoporous, annular, spherical, planar, aggregated, or layered. In embodiments, the source particulate and/or the functionalized particulate is characterized as having a surface area of about 20 m²/g to about 1500 m²/g, such as 100 m²/g to 1500 m²/g, or 200 m²/g to 1500 m²/g, or 300 m²/g to 1500 m²/g, or 400 m²/g to 1500 m²/g, or 500 m²/g to 1500 m²/g, or 600 m²/g to 1500 m²/g, or 700 m²/g to 1500 m²/g, or 800 m²/g to 1500 m²/g, or 900 m²/g to 1500 m²/g, or 1000 m²/g to 1500 m²/g, or 1100 m²/g to 1500 m²/g, or 1200 m²/g to 1500 m²/g, or 1300 m²/g to 1500 m²/g, or 1400 m²/g to 1500 m²/g, or 20 m²/g to 1200 m²/g, or 20 m²/g to 1000 m²/g, or 20 m²/g to 900 m²/g, or 20 m²/g to 800 m²/g, or 20 m²/g to 700 m²/g, or 20 m²/g to 600 m²/g, or 20 m²/g to 500 m²/g, or 20 m²/g to 400 m²/g, or 20 m²/g to 300 m²/g, or 20 m²/g to 200 m²/g, or 20 m²/g to 100 m²/g, or m²/g to 50 m²/g, or 50 m²/g to 100 m²/g, or 100 m²/g to 200 m²/g, or 200 m²/g to 300 m²/g, or 300 m²/g to 400 m²/g, or 400 m²/g to 500 m²/g, or 500 m²/g to 600 m²/g, or 600 m²/g to 700 m²/g, or 700 m²/g to 800 m²/g, or 800 m²/g to 900 m²/g, or 900 m²/g to 1000 m²/g, or 1000 m²/g to 1100 m²/g, or 1100 m²/g to 1200 m²/g, or 1200 m²/g to 1300 m²/g, or 1300 m²/g to 1400 m²/g, or 1400 m²/g to 1500 m²/g.

In embodiments, the source particulate and/or the functionalized particulate is characterized as having a mean particle size or an average particle size in the range of 1 nm-1000 nm, for example 1 nm-900 nm, or 1 nm-800 nm, or 1 nm-700 nm, or 1 nm-600 nm, or 1 nm-500 nm, or 1 nm-400 nm, or 1 nm-300 nm, or 1 nm-200 nm, or 1 nm-100 nm, or 1 nm-50 nm, or 1 nm-10 nm, or 10 nm-1000 nm, or 20 nm-1000 nm, or 100 nm-1000 nm, or 200 nm-1000 nm, or 300 nm-1000 nm, or 400 nm-1000 nm, or 500 nm-1000 nm, or 600 nm-1000 nm, or 700 nm-1000 nm, or 800 nm-1000 nm, or 900 nm-1000 nm, or 1 nm-5 nm, or 5 nm-10 nm, or 10 nm-15 nm, or 15 nm-20 nm, or 20 nm-30 nm, or 30 nm-40 nm, or 40 nm-50 nm, or 50 nm-60 nm, or 60 nm-70 nm, or 70 nm-80 nm, or 80 nm-90 nm, or 90 nm-100 nm, or 100 nm-110 nm, or 110 nm-120 nm, or 120 nm-130 nm, or 130 nm-140 nm, or 140 nm-150 nm, or 150 nm-160 nm, or 160 nm-170 nm, or 170 nm-180 nm, or 180 nm-190 nm, or 190 nm-200 nm, or 100 nm-200 nm, or 1 nm to 200 nm, or 5 nm to 200 nm, or 100 nm-150 nm, or 150 nm-200 nm, or 200 nm-250 nm, or 250 nm-300 nm, or 1 nm to 300 nm, or 5 nm to 300 nm, or 300 nm-350 nm, or 350 nm-400 nm, or 400 nm-450 nm, or 450 nm-500 nm, or 500 nm-600 nm, or 600 nm-700 nm, or 700 nm-800 nm, or 800 nm-900 nm.

In embodiments, the source particulate comprises, consists essentially of, or consists of silica. In embodiments the silica is a colloidal silica or a fumed silica. Colloidal silica is a stabilized aqueous dispersion of amorphous silicon dioxide particles. Colloidal silica is conventionally synthesized by polymerization of silicates in water and under alkaline conditions, resulting in formation of a stable aqueous dispersion of highly uniform, highly spherical nanoscale solid particles. Fumed silica is an amorphous, powdered (substantially dry) particulate synthesized by pyrolysis of silicon tetrachloride. Fumed silica particles have the same molecular composition as colloidal silica particles, but they are substantially dry and provided in powdered form instead of a stabilized liquid dispersion. Further, fumed silica primary particles are further fused as three-dimensional secondary particles; and the secondary particles may further be agglomerated as tertiary particles, whereas colloidal silica consists of or consists essentially of primary particles. The primary particle size of fumed silica is about 5 nm to 50 nm, providing a surface area of 50 m²/g-600 m²/g.

In embodiments, the source particulate comprises, consists essentially of, or consists of alumina. Alumina colloids (stabilized aqueous dispersions of alumina particles) are available commercially from several sources wherein an average particle size is about 200 nm or less, for example 1 nm-200 nm, or 1 nm-150 nm, or 1 nm-100 nm, or 1 nm-50 nm, or 1 nm-20 nm, or 1 nm-10 nm, or 10 nm-20 nm, or 20 nm-50 nm, or 50 nm-100 nm, or 100 nm-150 nm, or 150 nm-200 nm. In embodiments, the source particulate comprises, consists essentially of, or consists of alumina-coated silica. Alumina-coated silica colloids are commercially available from CD Bioparticles of Shirley, NY; or under the trade name LEVASIL® from Nouryon of Houston, TX. Alternatively, alumina-coated silica colloids may be synthesized, for example by using the techniques set forth in Jin et al., Colloids and Surfaces A: Physicochemical and Engineering Aspects Volume 441, pp. 170-177 (2014) or Chen et al., Ceramics International Volume 46, Issue 1, pp. 196-203 (2020).

In embodiments, the source particulate comprises, consists essentially of, or consists of a nanoclay. Nanoclays are layered mineral silicates (phyllosilicates) that vary according to the chemical composition and morphology. Suitable nanoclay particulates include talc (Mg₃[Si₄O₁₀(OH)₂]), vermiculite (similar to talc but including additional layers of water molecules), mica (KAl₂[AlSi₃O₁₀(OH)₂]), kaolin (Al₂[Si₂O₅(OH)₄]), montmorillonite (Mg_{0.33}Al_{1.67}[Si₄O₁₀(OH)₂](Ca, Na), (H₂O)ₙ), serpentine (Mg₃[Si₂O₅(OH)₄]) and sepiolite (Mg₄[Si₆O₁₅](OH)₂ 4H₂O) as well as more complex structures such as chlorite. In embodiments, the source particulate is halloysite, (Al₂Si₂O₅(OH)₄.2H₂O) a layered nanotube that is chemically similar to kaolin.

Since they are naturally sourced, clay particulates, including nanoclays, have variable and/or irregular dimensions. For example, the length of a halloysite nanotube cylinder ranges from 10 nanometers (nm) to 10 microns (μm), most often about 100 nm to about 2 μm, while the inner surface diameter (that is, the lumen diameter) is 5 nm to 150 nm, often about 15 nm, and the outer surface diameter is dictated by the number of layers, wherein one layer is reported by various sources to be 7 Å thick.

In embodiments, the source particulate comprises, consists essentially of, or consists of a reactive carbon nanoparticulate, such as a graphene nanoparticle or a carbon nanotube having hydroxyl or silanol moieties bonded thereto. Graphene nanoparticles, such as graphene quantum dots, are often characterized as a single thickness of a graphene sheet, but in fact in some embodiments can be up to about 5 graphene layers thick. In embodiments, reactive groups are added at the edge of the two-dimensional carbon “sheet” either inherently as part of the synthesis, or as a result of an extra step for this purpose. Some representative currently known methods of adding reactive groups to graphene nanoparticles are discussed in Bacon, M. et al., Part. Part. Syst. Charact. 2014, 31, 415-428.

Similarly, reactive groups have been attached to the surface of carbon nanotubes using thermochemical methodology or γ-irradiation. Surface modifications at the sidewall or at the ends of the tube can be achieved through covalent bonding. Suitable methods and examples of suitable reactive carbon nanotubes are found in e.g. Kuzmany H, et al., Synth Met. 2004; 141:113-122; Dettlaff-Weglikowska U. et al., Curr. Appl. Phys. 2002; 2:497-501; and Holzinger M. et al., Carbon 2004; 42:941-947.

In some embodiments, the source particulate is supplied or is synthesized as a colloid, that is, the source particulate is dispersed in a liquid. In some other embodiments, the source particulate is supplied as a powder, and the powder is dispersed in a liquid. Suitable dispersion liquids for dispersing a source particulate comprise, consist essentially of, or consist of linear, branched, or cyclic aliphatic alcohols having 1 to 6 carbon atoms, diols having 1 to 6 carbon atoms, alkyl ethers of alkylene glycols wherein the alkyl moiety has 1 to 6 carbon atoms (e.g., ethylene glycol mono-n-butyl ether), polyalkylene glycols, and mixtures thereof. Also useful as dispersion liquids are glycol and glycerol-based acetals and ketals, such as those formed from the condensation of e.g., glycerol with formaldehyde, acetone, or oxocarboxylic acids, semialdehydes, and esters thereof such as levulinic acid or an alkyl levulinate. In some embodiments, the dispersion liquid comprises, consists essentially of, or consists of water, methanol, ethanol, propanol, butanol, glycerol, ethylene glycol, ethylene glycol monoalkyl ether wherein the ether moiety comprises 1 to 6 carbon atoms, or a combination of two or more thereof. In some embodiments, the dispersion liquid consists essentially of or consists of water.

In embodiments, the amount of a source particulate dispersed in a source particulate dispersion or colloid is 1 wt % to 50 wt %, or 1 wt % to 40 wt %, or 1 wt % to 30 wt %, or 1 wt % to 20 wt %, or 1 wt % to 10 wt %, or 1 wt % to 5 wt %, or 5 wt % to 50 wt %, or 10 wt % to 50 wt %, or 20 wt % to 50 wt %, or 30 wt % to 50 wt %, or 40 wt % to 50 wt %, or 5 wt % to 25 wt %, or 10 wt % to 20 wt %, or 5 wt % to 15 wt %, or 10 wt % to 30 wt %, or 20 wt % to 30 wt % of the source particulate in the source particulate dispersion or colloid.

As mentioned above, the functionalized particulate comprises, consists essentially of, or consists of a source particulate having amine and epoxy groups covalently bonded to the surface of the particle. The functionalized particulate is formed by contacting a source particulate with a silane coupling agent having an amine group (“aminosilane”) and a silane coupling agent having an epoxy group (“epoxysilane”) under conditions that obtain hydrolysis and condensation of the silanes and cause the amine and epoxy groups to become covalently bonded to the surface of the source particulate.

In embodiments, the aminosilane is a silane compound including one or more amino groups, or any combination of two or more silane compounds that each include one or more amino groups. In embodiments, the aminosilane has the chemical formula (R¹O)ₘ(R²)₃₋ₘSiR³, wherein R¹ is H, a linear, cyclic, or branched alkyl, aryl, or alkaryl group, or [CH₂CHR⁴O]ₓCH₃ wherein x is an integer between 1 and 5 and R⁴ is independently H or CH₃ for each x; m is 1, 2, or 3; R² is an alkyl group having 1-3 carbons; and R³ is an organic moiety including at least one primary or secondary amine group. In embodiments R³ includes 1 to 20 carbons, that is, 1, 2, 3, 4, 5, 6, 7, 8, 9, 10, 11, 12, 13, 14, 15, 16, 17, 18, 19, or 20 carbons. In embodiments R₃ is a linear, cyclic, or branched alkyl, aryl, or alkaryl group including at least one primary or secondary amine group. In embodiments R³ includes one amine group, wherein the one amine group is a primary amine. In embodiments, R³ includes two amine groups, wherein one of the amine groups is a primary amine.

In embodiments, the aminosilane is selected from aminomethyltriethoxysilane, N-((3-aminoethyl)aminomethyltrimethoxysilane, aminomethylmethyldiethoxysilane, N-((3-aminoethyl)methyltriethoxysilane, N-(2-aminoethyl)-3-aminopropyltrimethoxysilane, γ-aminopropyltriethoxysilane, γ-aminopropyltrimethoxysilane, γ-aminopropylmethyldiethoxysilane, γ-aminoisobutyltrimethoxysilane, N-((3-aminoethyl)-γ-aminopropyltrimethoxysilane, N-((3-aminoethyl)-γ-aminopropylmethyldimethoxysilane, N-(2-aminoethyl)-3-aminopropyltris(2-ethylhexoxy)silane, N-(aminoethylaminomethyl)phenyltrimethoxysilane, trimethoxysilylpropylenetriamine, bis(2-hydroxyethyl)-3-aminopropyltrimethoxysilane, and N-(6-aminohexyl)-3-aminopropyltrimethoxy silane. Further specific examples of useful aminosilanes include those mentioned in Patent Publication No. US 2023/0332041, the disclosures of which are incorporated by reference herein.

In embodiments, the epoxysilane has the chemical formula (R¹O)ₘ(R²)₃₋ₘSiR⁵, wherein R¹, R² and m are the same as for the aminosilane; and and R⁵ is an organic moiety including at least one oxiranyl or epoxy (epoxide) group. In embodiments R⁵ includes 1 to 20 carbons, that is, 1, 2, 3, 4, 5, 6, 7, 8, 9, 10, 11, 12, 13, 14, 15, 16, 17, 18, 19, or 20 carbons; and at least one oxygen atom associated with an epoxy moiety. In embodiments R⁵ includes two oxygen atoms, both of which are associated with an oxiranyl moiety. In embodiments R₃ is a linear, cyclic, or branched alkyl, aryl, or alkaryl group including at least one epoxy or oxiranyl group. In embodiments R⁵ includes one epoxy group or one oxiranyl group.

In embodiments, the epoxysilane is selected from 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 5,6-epoxyhexyltrimethoxysilane, and 5,6-epoxyhexyltriethoxysilane.

Methods of covalently bonding silane coupling agents to nanoparticles having hydroxyl or silanol on the surface thereof, such as metal oxide nanoparticles e.g. silica and alumina, are well known to those of ordinary skill in the art. In embodiments, one or more such methods are useful herein for bonding the epoxysilane and/or aminosilane to the surface of the source particulates, in order to obtain a functionalized particulate suitable for use in the instantly described compositions.

In embodiments, covalent bonding of the aminosilane, the epoxysilane, or both the aminosilane and the epoxysilane to a source particulate or an intermediate particulate is obtained by contacting the aminosilane, the epoxysilane, or both the aminosilane and the epoxysilane with the source particulate or the intermediate particulate in an aqueous medium at pH of 12 or less, for example pH of 2 to 12, or 2 to 11, or 2 to 10, or 2 to 9, or 2 to 8, or 2 to 7, or 7 to 7.5, or 7.5 to 8, or 8 to 8.5, or 8.5 to 9, or 9 to 9.5, or 9.5 to 10, or 10 to 10.5, or 10.5 to 11, or 11 to 11.5, or 11.5 to 12. In embodiments the pH of the contacting is between 10 and 12. In embodiments the pH is maintained to be at least 10 throughout the contact period. In embodiments, the contacting is carried out in a source particulate dispersion or colloid having 1 wt % to 50 wt %, or 1 wt % to 40 wt %, or 1 wt % to 30 wt %, or 1 wt % to 20 wt %, or 1 wt % to 10 wt %, or 1 wt % to 5 wt %, or 5 wt % to 50 wt %, or 10 wt % to 50 wt %, or 20 wt % to 50 wt %, or 30 wt % to 50 wt %, or 40 wt % to 50 wt %, or 5 wt % to 25 wt %, or 10 wt % to 20 wt %, or 5 wt % to 15 wt %, or 10 wt % to 30 wt %, or 20 wt % to 30 wt % of the source particulate in an aqueous dispersion or colloid.

In embodiments, the aminosilane, the epoxysilane, and the source particulate are contacted in any order. In embodiments, the aminosilane, the epoxysilane, and the source particulate are contacted substantially contemporaneously. In other embodiments, the source particulate is contacted with an aminosilane to obtain an intermediate particulate having amine groups bonded to the surface thereof, and the intermediate particulate is contacted with an epoxysilane to form a functionalized particulate that includes both amine and epoxy groups bonded to the surface thereof. In still other embodiments, the source particulate is contacted with an epoxysilane to obtain an intermediate particulate having epoxy groups bonded to the surface thereof, and the intermediate particulate is contacted with an aminosilane to form a functionalized particulate that includes both amine and epoxy groups bonded to the surface thereof. In still other embodiments, an aminosilane and an epoxysilane are combined, such as by admixing, and the source particulate is contacted with the combined silane to form a functionalized particulate that includes both amine and epoxy groups bonded to the surface thereof. In any one or more of the foregoing embodiments, the aminosilane, the epoxysilane, or both the aminosilane and the epoxysilane are subjected to hydrolytic conditions prior to contacting the silane with the source particulate or an intermediate particulate.

In embodiments, the contacting is obtained in a single action to combine two or more of the reagents, that is, two or more of the source particulate, the epoxysilane, and the aminosilane; in other embodiments two or more reagents are contacted in aliquots, e.g. by continuous slow addition or by periodic addition of a selected amount of a reagent, over a selected period of time that is often between 5 minutes and 24 hours. In embodiments, the contacting is carried out at a temperature greater than 0° C. and less than 100° C., often between 40° C. and 95° C., or between 50° C. and 80° C. In embodiments, the contacting is carried out by contacting one or both of the aminosilane and epoxysilane with a source particulate dispersion or colloid. Source particulates supplied in or synthesized in a dispersion liquid are described above, and in embodiments such dispersions or colloids are used as supplied or synthesized for the contacting with one or more of the epoxysilane and the aminosilane.

In embodiments, the contacting of the source particulate, the epoxysilane, and the aminosilane described above obtains a functionalized particulate, that is, a particulate having both epoxy and amine groups—collectively, functional groups—covalently bonded to the surface thereof. In embodiments, the functionalized particulate includes 0.1 μmol to 15.00 μmol of functional groups per square meter of the source particulate surface area, for example 0.1 μmol to 14.00 μmol, 0.1 μmol to 13.00 μmol, 0.1 μmol to 12.00 μmol, 0.1 μmol to 11.00 μmol, 0.1 μmol to 10.00 μmol, 0.1 μmol to 9.00 μmol, 0.1 μmol to 8.00 μmol, 0.1 μmol to 7.00 μmol, 0.1 μmol to 6.00 μmol, 0.1 μmol to 5.00 μmol, 0.1 μmol to 4.00 μmol, 0.1 μmol to 3.00 μmol, 0.1 μmol to 2.80 μmol, 0.1 μmol to 2.60 μmol, 0.1 μmol to 2.40 μmol, 0.1 μmol to 2.20 μmol, 0.1 μmol to 2.00 μmol, 0.1 μmol to 1.80 μmol, 0.1 μmol to 1.60 μmol, 0.1 μmol to 1.40 μmol, 0.1 μmol to 1.20 μmol, 0.1 μmol to 1.00 μmol, 0.1 μmol to 0.90 μmol, 0.1 μmol to 0.80 μmol, 0.1 μmol to 0.70 μmol, 0.1 μmol to 0.60 μmol, 0.1 μmol to 0.50 μmol, 0.1 μmol to 0.4 μmol, 0.1 μmol to 0.3 μmol, 0.3 μmol to 15.00 μmol, 0.5 μmol to 15.00 μmol, 0.6 μmol to 15.00 μmol, 0.7 μmol to 15.00 μmol, 0.8 μmol to 15.00 μmol, 0.9 μmol to 15.00 μmol, 1.00 μmol to 15.00 μmol, 1.20 μmol to 15.00 μmol, 1.40 μmol to 15.00 μmol, 1.60 μmol to 15.00 μmol, 1.80 μmol to 15.00 μmol, 2.00 μmol to 15.00 μmol, 2.20 μmol to 15.00 μmol, 2.40 μmol to 15.00 μmol, 2.60 μmol to 15.00 μmol, 2.80 μmol to 15.00 μmol, 3.00 μmol to 15.00 μmol, 4.00 μmol to 15.00 μmol, 5.00 μmol to 15.00 μmol, 6.00 μmol to 15.00 μmol, 7.00 μmol to 15.00 μmol, 8.00 μmol to 15.00 μmol, 9.00 μmol to 15.00 μmol, 10.00 μmol to 15.00 μmol, 11.00 μmol to 15.00 μmol, 12.00 μmol to 15.00 μmol, 13.00 μmol to 15.00 μmol, 14.00 μmol to 15.00 μmol, 0.1 μmol to 0.2 μmol, 0.2 μmol to 0.3 μmol, 0.3 μmol to 0.4 μmol, 0.4 μmol to 0.5 μmol, 0.5 μmol to 0.6 μmol, 0.6 μmol to 0.7 μmol, 0.7 μmol to 0.8 μmol, 0.8 μmol to 0.9 μmol, 0.9 μmol to 1.00 μmol, 1.00 μmol to 1.20 μmol, 1.20 μmol to 1.40 μmol, 1.40 μmol to 1.60 μmol, 1.60 μmol to 1.80 μmol, 1.80 μmol to 2.00 μmol, 2.00 μmol to 2.20 μmol, 2.20 μmol to 2.40 μmol, 2.40 μmol to 2.60 μmol, 2.60 μmol to 2.80 μmol, 2.80 μmol to 3.00 μmol, 3.00 μmol to 4.00 μmol, 4.00 μmol to 5.00 μmol, 5.00 μmol to 6.00 μmol, 6.00 μmol to 7.00 μmol, 7.00 μmol to 8.00 μmol, 8.00 μmol to 9.00 μmol, 9.00 μmol to 10.00 μmol, 10.00 μmol to 11.00 μmol, 11.00 μmol to 12.00 μmol, 12.00 μmol to 13.00 μmol, 13.00 μmol to 14.00 μmol, or 14.00 μmol to 15.00 μmol of functional groups per square meter of the source particulate surface area.

In embodiments, the ratio of epoxy groups to amine groups covalently bonded to the surface of the functionalized particulate is from 100:1 to 1:100, for example 50:1 to 1:100, or 100:1 to 1:50, or 40:1 to 1:100, or 100:1 to 1:40, or 30:1 to 1:100, or 100:1 to 1:30, or 20:1 to 1:100, or 100:1 to 1:20, or 10:1 to 1:100, or 100:1 to 1:10, or 5:1 to 1:100, or 100:1 to 1:5, or 1:1 to 1:100, or 100:1 to 1:1, or 50:1 to 1:50, or 40:1 to 1:40, or 30:1 to 1:30, or 20:1 to 1:20, or 10:1 to 1:10, or 5:1 to 1:5, or 2:1 to 1:2, or 10:1 to 1:1, or 1:1 to 1:10, or 5:1 to 1:1, or 1:1 to 1:5, or 2:1 to 1:1, or 1:1 to 1:2, or about 100:1, or about 50:1, or about 40:1, or about 30:1, or about 20:1, or about 10:1, or about 5:1, or about 4:1, or about 3:1, or about 2:1, or about 1:1, or about 1:2, or about 1:3, or about 1:4, or about 1:5, or about 1:10, or about 1:20, or about 1:30, or about 1:40, or about 1:50, or about 1:100.

In embodiments, the functionalized particulate is a mixture of two or more different functionalized particulates, that is, functionalized particulates having different source particulate chemistries, different particle sizes, different amounts of amine groups, epoxy groups, both amine and epoxy groups bonded thereto, different total amounts of functional groups bonded thereto; or another such physicochemical difference. In such embodiments, the two or more different functionalized particulates are present in the treatment composition in any ratio therein.

In embodiments, the functionalized particulate is a mixture of one or more amine-functionalized particulates with one or more epoxy-functionalized particulates, wherein the amine-functionalized particulate excludes or substantially excludes epoxy groups covalently bonded to the surface thereof; and the epoxy-functionalized particulate excludes or substantially excludes amine groups covalently bonded to the surface thereof. In such embodiments, one or more amine-functionalized particulates is combined in a mixture with one or more epoxy-functionalized particulates in a weight ratio of 100:1 to 1:100, for example 50:1 to 1:100, or 100:1 to 1:50, or 40:1 to 1:100, or 100:1 to 1:40, or 30:1 to 1:100, or 100:1 to 1:30, or 20:1 to 1:100, or 100:1 to 1:20, or 10:1 to 1:100, or 100:1 to 1:10, or 5:1 to 1:100, or 100:1 to 1:5, or 1:1 to 1:100, or 100:1 to 1:1, or 50:1 to 1:50, or 40:1 to 1:40, or 30:1 to 1:30, or 20:1 to 1:20, or 10:1 to 1:10, or 5:1 to 1:5, or 2:1 to 1:2, or 10:1 to 1:1, or 1:1 to 1:10, or 5:1 to 1:1, or 1:1 to 1:5, or 2:1 to 1:1, or 1:1 to 1:2, or about 100:1, or about 50:1, or about 40:1, or about 30:1, or about 20:1, or about 10:1, or about 5:1, or about 4:1, or about 3:1, or about 2:1, or about 1:1, or about 1:2, or about 1:3, or about 1:4, or about 1:5, or about 1:10, or about 1:20, or about 1:30, or about 1:40, or about 1:50, or about 1:100. In some such embodiments, the amine-functionalized particulate is formed from a source particulate that is different from the source particulate used to form the epoxy-functionalized particulate. As described herein above, different source particulates may include different source particulate chemistries, different particle sizes, different amounts of functional groups, or another such physicochemical difference.

In embodiments, a composition including a CI and a functionalized particulate is further combined or mixed with a solvent to form a treatment composition that is useful for coating a surface to obtain corrosion inhibition thereof. Accordingly, in embodiments, the treatment compositions comprise, consists essentially of, or consist of a CI, a functionalized particulate, and a solvent.

In embodiments, the solvent comprises, consists essentially of, or consists of xylene, benzene, toluene, aromatic naphtha solvents including HAN, diesel, kerosene, fuel oil, or a combination of two or more thereof. In embodiments, the solvent comprises, consists essentially of, or consists of a mixture of xylene, benzene, toluene, aromatic naphtha solvents including HAN, diesel, kerosene, fuel oil, or a combination of two or more thereof with water; a water-miscible or partially water-miscible solvent such as C1-C6 alkanols, C1-C4 aldehydes, C3-C5 ketones, and C2-C6 diols, triols, and polyols, including glycerol and sugar alcohols; or a combination of two or more thereof.

In embodiments, the treatment compositions include between 10 wt % and 90 wt % solvent based on the weight of the treatment composition, for example 20 wt % to 90 wt %, or 30 wt % to 90 wt %, or 40 wt % to 90 wt %, or 50 wt % to 90 wt %, or 60 wt % to 90 wt %, or 70 wt % to 90 wt %, or 80 wt % to 90 wt %, or 10 wt % to 80 wt %, or 10 wt % to 70 wt %, or 10 wt % to 60 wt %, or 10 wt % to 50 wt %, or 10 wt % to 40 wt %, or 10 wt % to 30 wt %, or 10 wt % to 25 wt %, or 10 wt % to 20 wt %, or 10 wt % to 15 wt %, or 15 wt % to 20 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt %, or 50 wt % to 55 wt %, or 55 wt % to 60 wt %, or 60 wt % to 65 wt %, or 65 wt % to 70 wt %, or 70 wt % to 75 wt %, or 75 wt % to 80 wt %, or 80 wt % to 85 wt %, or 85 wt % to 90 wt %, or 10 wt % to 20 wt %, or 20 wt % to 30 wt %, or 30 wt % to 40 wt %, or 40 wt % to 50 wt %, or 50 wt % to 60 wt %, or 60 wt % to 70 wt %, or 70 wt % to 80 wt %, or 80 wt % to 90 wt %, or 10 wt % to 30 wt %, or 20 wt % to 40 wt %, or 40 wt % to 60 wt %, or 60 wt % to 80 wt %, or 30 wt % to 50 wt %, or 50 wt % to 70 wt %, or 70 wt % to 90 wt % of the solvent based on the weight of the treatment composition. In embodiments, the solvent is a substantially a single compound; in other embodiments the solvent is a mixture of two or more compounds. In embodiments, the solvent comprises, consists essentially of, or consists of water. In embodiments, the solvent comprises, consists essentially of, or consists of a compound that is partially or completely miscible with water. In embodiments, the solvent comprises, consists essentially of, or consists of a compound that is immiscible with water. In embodiments, the solvent comprises, consists essentially of, or consists of a compound that is a liquid at 25° C./1 atm and has a flashpoint of 100° C. or less. In embodiments, the solvent includes aromatic functionality. In embodiments, the solvent comprises, consists essentially of, or consists of benzene, toluene, ethylbenzene, xylene, aromatic naphtha, or a combination of two or more thereof.

In embodiments, the treatment compositions include between 0.1 wt % and 2.0 wt % of a functionalized particulate based on the weight of the treatment composition, for example 0.1 wt % to 1.8 wt %, or 0.1 wt % to 1.6 wt %, or 0.1 wt % to 1.4 wt %, or 0.1 wt % to 1.2 wt %, or 0.1 wt % to 1.0 wt %, or 0.1 wt % to 0.8 wt %, or 0.1 wt % to 0.6 wt %, or 0.1 wt % to 0.4 wt %, or 0.1 wt % to 0.2 wt %, or 0.2 wt % to 2.0 wt %, or 0.4 wt % to 2.0 wt %, or 0.6 wt % to 2.0 wt %, or 0.8 wt % to 2.0 wt %, or 1.0 wt % to 2.0 wt %, or 1.2 wt % to 2.0 wt %, or 1.4 wt % to 2.0 wt %, or 1.6 wt % to 2.0 wt %, or 1.8 wt % to 2.0 wt %, or 0.1 wt % to 0.3 wt %, or 0.2 wt % to 0.4 wt %, or 0.3 wt % to 0.5 wt %, or 0.4 wt % to 0.6 wt %, or 0.5 wt % to 0.7 wt %, or 0.6 wt % to 0.8 wt %, or 0.7 wt % to 0.9 wt %, or 0.8 wt % to 1.0 wt %, or 0.9 wt % to 1.1 wt %, or 1.0 wt % to 1.2 wt %, or 1.1 wt % to 1.3 wt %, or 1.2 wt % to 1.4 wt %, or 1.3 wt % to 1.5 wt %, or 1.4 wt % to 1.6 wt %, or 1.5 wt % to 1.7 wt %, or 1.6 wt % to 1.8 wt %, or 1.7 wt % to 1.9 wt % of a functionalized particulate based on the weight of the treatment composition.

In embodiments, the treatment compositions include between 10 wt % and 90 wt % of the CI based on the weight of the treatment composition, for example 20 wt % to 90 wt %, or 30 wt % to 90 wt %, or 40 wt % to 90 wt %, or 50 wt % to 90 wt %, or 60 wt % to 90 wt %, or 70 wt % to 90 wt %, or 80 wt % to 90 wt %, or 10 wt % to 80 wt %, or 10 wt % to 70 wt %, or 10 wt % to 60 wt %, or 10 wt % to 50 wt %, or 10 wt % to 40 wt %, or 10 wt % to 30 wt %, or 10 wt % to 20 wt %, or 10 wt % to 15 wt %, or 15 wt % to 20 wt %, or 15 wt % to 25 wt %, or 20 wt % to 25 wt %, or 25 wt % to 30 wt %, or 30 wt % to 35 wt %, or 35 wt % to 40 wt %, or 40 wt % to 45 wt %, or 45 wt % to 50 wt %, or 50 wt % to 55 wt %, or 55 wt % to 60 wt %, or 60 wt % to 65 wt %, or 65 wt % to 70 wt %, or 70 wt % to 75 wt %, or 75 wt % to 80 wt %, or 80 wt % to 85 wt %, or 85 wt % to 90 wt %, or 10 wt % to 30 wt %, or 20 wt % to 40 wt %, or 30 wt % to 50 wt %, or 40 wt % to 60 wt %, or 50 wt % to 70 wt %, or 60 wt % to 80 wt %, or 70 wt % to 90 wt % of the CI based on the weight of the treatment composition.

In embodiments, the treatment compositions include a mixture of a CI and a functionalized particulate at a weight ratio of 1000:1 to 2:1 [CI]:[functionalized particulate], for example 1000:1 to 5:1, or 1000:1 to 10:1, or 1000:1 to 20:1, or 1000:1 to 30:1, or 1000:1 to 40:1, or 1000:1 to 50:1, or 1000:1 to 60:1, or 1000:1 to 70:1, or 1000:1 to 80:1, or 1000:1 to 90:1, or 1000:1 to 100:1, or 1000:1 to 200:1, or 1000:1 to 300:1, or 1000:1 to 400:1, or 1000:1 to 500:1, or 1000:1 to 600:1, or 1000:1 to 700:1, or 1000:1 to 800:1, or 1000:1 to 900:1, or 900:1 to 2:1, or 800:1 to 2:1, or 700:1 to 2:1, or 600:1 to 2:1, or 500:1 to 2:1, or 400:1 to 2:1, or 300:1 to 2:1, or 200:1 to 2:1, or 100:1 to 2:1, or 90:1 to 2:1, or 80:1 to 2:1, or 70:1 to 2:1, or 60:1 to 2:1, or 50:1 to 2:1, or 40:1 to 2:1, or 30:1 to 2:1, or 20:1 to 2:1, or 10:1 to 2:1, or 5:1 to 2:1, or 2:1 to 10:1, or 10:1 to 20:1, or 20:1 to 30:1, or 30:1 to 40:1, or 40:1 to 50:1, or 50:1 to 60:1, or 60:1 to 70:1, or 70:1 to 80:1, or 80:1 to 90:1, or 90:1 to 100:1, or 100:1 to 200:1, or 200:1 to 300:1, or 300:1 to 400:1, or 400:1 to 500:1, or 500:1 to 600:1, or 600:1 to 700:1, or 700:1 to 800:1, or 800:1 to 900:1, or about 2:1, or about 5:1, or about 10:1, or about 20:1, or about 30:1, or about 40:1, or about 50:1, or about 60:1, or about 70:1, or about 80:1, or about 90:1, or about 100:1, or about 200:1, or about 300:1, or about 400:1, or about 500:1, or about 600:1, or about 700:1, or about 800:1, or about 900:1, or about 1000:1 [CI]: [functionalized particulate] by weight.

In embodiments, the treatment compositions described herein include one or more adjuvants. Adjuvants are materials or compounds that improve the ease of applying a treatment composition to a surface to form a coating thereon; and/or increase the durability of a coating of the treatment composition formed on a surface; and/or increase the corrosion inhibition of a surface; and/or add a new type of performance to the treatment composition or to a coating formed by applying a treatment composition to a surface, such as antimicrobial, antifungal, antifouling, and/or paraffin inhibition performance.

In embodiments, an adjuvant or a combination of two or more adjuvants are present in the treatment composition in an amount between 0.01 wt % and 10 wt % based on the weight of treatment composition, such as 0.01 wt % to 0.1 wt %, or 0.01 wt % to 1 wt %, or 0.1 wt % to 1 wt %, or 1 wt % to 5 wt %, or 5 wt % to 10 wt %, or 1 wt % to 2 wt %, or 2 wt % to 3 wt %, or 3 wt % to 4 wt %, or 4 wt % to 5 wt %, or 5 wt % to 6 wt %, or 6 wt % to 7 wt %, or 7 wt % to 8 wt %, or 8 wt % to 9 wt %, or 9 wt % to 10 wt % based on the weight of treatment composition. In embodiments, one or more treatment compositions disclosed herein further include two or more adjuvants, wherein the combination of two or more adjuvants is present in the treatment composition in an amount between 10 wt % and 20 wt %, such as 10 wt % to 12 wt %, or 12 wt % to 14 wt %, or 14 wt % to 16 wt %, or 16 wt % to 18 wt %, or 18 wt % to 20 wt %, or 10 wt % to 15 wt %, or 15 wt % to 20 wt %, or about 10 wt %, or about 11 wt %, or about 13 wt %, or about 14 wt %, or about 15 wt %, or about 16 wt %, or about 17 wt %, or about 18 wt %, or about 19 wt %, or about 20 wt % based on the weight of treatment composition.

In embodiments, the one or more adjuvants is selected from anti-fouling agents, anti-microbial agents, hydrogen sulfide scavengers, anti-emulsifiers, anti-foaming agents, emulsifiers, foamers, paraffin inhibitors, asphaltene inhibitors, hydrate inhibitors, or a combination of two or more thereof.

In embodiments, a suitable adjuvant included in one or more treatment compositions comprises, consists essentially of, or consists of an antifouling agent. Antifouling agents are materials or compounds that reduce or eliminate the deposition of solids on a surface. Antifouling agents include, but are not limited to, copolymers of unsaturated fatty acids, primary diamines, and acrylic acid; copolymers of methacrylamidopropyl trimethylammonium chloride with acrylic acid and/or acrylamide; copolymers of ethylene glycol and propylene glycol; and blends of two or more thereof.

In embodiments, a suitable adjuvant included in one or more treatment compositions comprises, consists essentially of, or consists of an antimicrobial agent. Antimicrobial agents include, but are not limited to, compounds with a microbiostatic, disinfectant, or sterilization effect on a liquid material when added thereto. Nonlimiting examples of antimicrobials include bactericides, fungicides, nematicides, and the like. Bactericides include active chlorine disinfectants, e.g. including hypochlorites, chlorine dioxide, and the like; phenols such as triclosan, phenol itself, thymol, and the like; cationic surfactants such as quaternary ammonium surfactants, chlorhexidine, and the like; ozone, permanganates, colloidal silver, silver nitrate, copper based compounds, iodine preparations, peroxides, and strong acids and strong alkalis. Fungicides include, but are not limited to, strobilurins such as azoxystrobin, trifloxystrobin and pyraclostrobin; triazoles and anilino-pyrimidines such as tebuconazole, cyproconazole, triadimefon, pyrimethanil; and additionally compounds such as triadimefon, benomyl, captan, chlorothalonil, copper sulfate, cyproconazole, dodine, flusilazole, flutolanil, fosetyl-al, gallex, mancozeb, metalaxyl, prochloraz, propiconazole, tebuconazole, thiophanate methyl, triadimenol, tridimefon, triphenyltin hydroxide, ziram, and the like.

In accordance with the treatment compositions disclosed herein, methods of treating a surface comprise, consist essentially of, or consist of combining or mixing a functionalized particulate, a CI, and a solvent to form a treatment composition; and contacting the treatment composition with a surface to form a treated surface. In embodiments, the methods further include combining one or more adjuvants with the treatment composition.

In embodiments, the surface is a metal surface, a glass surface, a plastic surface, or a combination of two or more thereof. In embodiments, the metal surface is a carbon steel surface, a steel alloy surface, a stainless steel surface, a copper alloy surface, a yellow metal surface, or a combination of two or more thereof. In embodiments, the surface is an interior surface of a conduit such as a pipe or tube, separator, containment such as a tank or vat, or a portion of such interior surface. In embodiments, the surface is an exterior surface of a conduit, separator, or containment, or a portion of such exterior surface. In embodiments, one or more conduits, separators, or containments are part of a well completion string of a producing well. In embodiments, the surface is located on a wellbore production string, on a water treatment facility, on a boiler, on a geothermal heat pump system, on a nuclear processing facility, on a water cooling tower, or on a combination of two or more thereof.

In embodiments, the treated surfaces comprise, consist essentially of, or consist of a surface having a coating disposed thereon, wherein the coating comprises, consists essentially of, or consists of a mixture of a CI and a functionalized particulate. In embodiments, the CI and the functionalized particulate are present in the coating mixture at a weight ratio of 1000:1 to 5:1 [CI]:[functionalized particulate], for example 1000:1 to 10:1, or 1000:1 to 20:1, or 1000:1 to 30:1, or 1000:1 to 40:1, or 1000:1 to 50:1, or 1000:1 to 60:1, or 1000:1 to 70:1, or 1000:1 to 80:1, or 1000:1 to 90:1, or 1000:1 to 100:1, or 1000:1 to 200:1, or 1000:1 to 300:1, or 1000:1 to 400:1, or 1000:1 to 500:1, or 1000:1 to 600:1, or 1000:1 to 700:1, or 1000:1 to 800:1, or 1000:1 to 900:1, or 900:1 to 5:1, or 800:1 to 5:1, or 700:1 to 5:1, or 600:1 to 5:1, or 500:1 to 5:1, or 400:1 to 5:1, or 300:1 to 5:1, or 200:1 to 5:1, or 100:1 to 5:1, or 90:1 to 5:1, or 80:1 to 5:1, or 70:1 to 5:1, or 60:1 to 5:1, or 50:1 to 5:1, or 40:1 to 5:1, or 30:1 to 5:1, or 20:1 to 5:1, or 10:1 to 5:1, or 10:1 to 20:1, or 20:1 to 30:1, or 30:1 to 40:1, or 40:1 to 50:1, or 50:1 to 60:1, or 60:1 to 70:1, or 70:1 to 80:1, or 80:1 to 90:1, or 90:1 to 100:1, or 100:1 to 200:1, or 200:1 to 300:1, or 300:1 to 400:1, or 400:1 to 500:1, or 500:1 to 600:1, or 600:1 to 700:1, or 700:1 to 800:1, or 800:1 to 900:1, or about 10:1, or about 20:1, or about 30:1, or about 40:1, or about 50:1, or about 60:1, or about 70:1, or about 80:1, or about 90:1, or about 100:1, or about 200:1, or about 300:1, or about 400:1, or about 500:1, or about 600:1, or about 700:1, or about 800:1, or about 900:1, or about 1000:1 [CI]:[functionalized particulate] by weight.

In some embodiments, contacting a surface with the treatment composition is coating the surface with the treatment composition. In embodiments, contacting the surface is accomplished in a continuous process; in other embodiments, contacting the surface is accomplished in a batchwise process. In embodiments, the surface is coated with the treatment composition at a coating thickness of 1 μm to 1 mm, for example 1 μm to 900 μm, or 1 μm to 800 μm, or 1 μm to 700 μm, or 1 μm to 600 μm, or 1 μm to 500 μm, or 1 μm to 400 μm, or 1 μm to 300 μm, or 1 μm to 200 μm, or 1 μm to 100 μm, or 1 μm to 50 μm, or 1 μm to 25 μm, or 1 μm to 10 μm, or 10 μm to 1 mm, or 25 μm to 1 mm, or 50 μm to 1 mm, or 100 μm to 1 mm, or 200 μm to 1 mm, or 300 μm to 1 mm, or 400 μm to 1 mm, or 500 μm to 1 mm, or 600 μm to 1 mm, or 700 μm to 1 mm, or 800 μm to 1 mm, or 900 μm to 1 mm, or 10 μm to 100 μm, or 100 μm to 200 μm, or 200 μm to 300 μm, or 300 μm to 400 μm, or 400 μm to 500 μm, or 500 μm to 600 μm, or 600 μm to 700 μm, or 700 μm to 800 μm, or 800 μm to 900 μm, or 100 μm to 300 μm, or 200 μm to 400 μm, or 300 μm to 500 μm, or 400 μm to 600 μm, or 500 μm to 700 μm, or 600 μm to 800 μm, or 700 μm to 900 μm, or 800 μm to 1 mm, to form the treated surface.

In embodiments, a treatment composition is applied to a surface using a batchwise treatment method. Suitable batchwise treatment methods include dip coating, brush coating, or spray coating. In embodiments, the batchwise treatment method is pigging. In embodiments, pigging is carried out using a smart pig, a spray pig, a smart spray pig, or a combination of two or more thereof.

In embodiments, surfaces usefully treated by contacting with the treatment compositions include interior and/or exterior surfaces or portions of interior and/or exterior surfaces of conduits, containments, separators, and combinations of these. In embodiments one or more surfaces usefully treated by contacting with the treatment compositions are located on a wellbore production string, on a water treatment facility, on a boiler, on a geothermal heat pump system, on a nuclear processing facility, on a water cooling tower, or a combination of two or more thereof. In embodiments the pipe or containment is further subjected to a fluid flow, such as a flow of crude oil and/or produced water that contacts the treated interior surface.

A treated surface formed in accordance with the methods disclosed herein is a surface having a coating disposed on at least a portion thereof, wherein the coating includes a CI and a functionalized particulate. Accordingly, disclosed herein is a coating disposed on a surface, the coating comprising, consisting essentially of, or consisting of a mixture of a CI and a functionalized particulate. The coating comprises, consists essentially of, or consists of a CI and a functionalized particulate. In embodiments, the treated surfaces have an unexpectedly long duration of corrosion inhibiting performance. Unexpectedly, the treated surfaces formed in accordance with the methods disclosed herein have improved the duration of corrosion inhibition performance when compared to the performance of the same corrosion inhibitor applied to the same surface in the same amount but in the absence of the functionalized particulate.

Accordingly, in embodiments the methods described herein comprise, consist essentially of, or consist of mixing a CI and a functionalized particulate with a solvent to form a treatment composition; contacting a surface with the treatment composition to form a treated surface; and contacting the treated surface with an aqueous fluid flow having one or more corrodents present therein, that is, dissolved or dispersed therein. In embodiments, the fluid flow is obtained from a wellbore production string, a water treatment facility, a boiler, a geothermal heat pump system, a nuclear processing facility, a water cooling tower, or a combination of two or more thereof. In embodiments, the fluid flow is a flow of crude oil and/or produced water. In embodiments, the corrodent present in the fluid flow comprises, consists essentially of, or consists of H₂S. In embodiments, the corrodent comprises dissolved CO₂, an organic acid, a mineral acid, or a combination of two or more thereof. In embodiments, a surface treated in accordance with the methods herein obtains improved corrosion inhibition durability when subjected to a corrodent-laden fluid flow, when compared to the same CI applied to the same surface in the same amount but in the absence of the functionalized particulate.

Unexpectedly, in embodiments we have observed that the treated interior surfaces obtain improved performance durability during such fluid flow, when compared to the same CI amine applied to the same surface(s) in the same amount, but in the absence of the functionalized particulate. Stated differently, when a treated surface including an CI and a functionalized particulate coated thereon, is subsequently contacted with a fluid including a corrodent, corrosion of the treated surface is inhibited for a longer period of time than the same surface contacted with the same corrosion inhibitor but in the absence of the functionalized particulate, then contacted with the same corrodent-bearing fluid.

In embodiments, we have observed that the treated surfaces described herein have improved duration of corrosion inhibition performance when compared to performance of surfaces treated with the same CI in the same amount, but in the absence of the functionalized particulate. In embodiments, the duration of maintaining or exceeding a selected level corrosion inhibition that is obtained by the treated surfaces is at least 10% longer, in embodiments 10%-50% longer, or 50%-100% longer, or 100%-200% longer, or 200%-300% longer, or 300%-400% longer, or even 400%-500% longer than the same level of corrosion inhibition obtained by the same surfaces treated with the same CI in the same amount, but in the absence of the functionalized particulate. In embodiments, the percentage of corrosion inhibition obtained by the treated surfaces is at least 10% greater, in embodiments 10%-20% greater, or 20%-30% greater, or 30%-40% greater, or 40%-50% greater, or 50%-60% greater, or 60%-70% greater, or 70%-80% greater, or 80%-90% greater, or 90%-100% greater, or 100%-110% greater, or 110%-120% greater, or 120%-130% greater, or 130%-140% greater, or 140%-150% greater, or 150%-160% greater, or 160%-170% greater, or 170%-180% greater, or 180%-190% greater, or even 190%-200% greater inhibition obtained by the same surfaces treated with the same CI in the same amount, but in the absence of the functionalized particulate.

Without being limited by theory, we believe that after contacting a surface—such as an interior surface of a pipe or containment—with a treatment composition as described herein, the functionalized particulate assists in aggregation, flocculation, and/or precipitation of the CI onto the surface. Alternatively, also without being limited by theory, the functionalized particulate may itself adsorb to the surface, in embodiments immobilizing or trapping the CI therewith. Further, the epoxy groups present on the surface of the functionalized particulate may react with one or more amine groups of an amine-functional CI, causing the CI to bond to the surface of the functionalized particulate and thereby increasing compatibility of the functionalized particulate with the CI. Accordingly, in embodiments, we have observed that the treated surfaces have improved duration of corrosion inhibition performance when compared to performance of the same CI applied to the same surface in the same amount, but in the absence of the functionalized particulate.

### Experimental Section

Colloidal silica (CAS No. 7631-86-9) was combined with 3-glycidoxypropyltrimethoxysilane (CAS Number 2530-83-8) to create an intermediate colloidal dispersion of silica functionalized with glycidoxy groups employing conventional literature procedures. The intermediate colloidal dispersion was added to a glass reactor and diluted to 3 wt % solids with distilled water. The reactor was fitted with a thermocouple and inlet for dropwise addition to the reactor, and the contents of the reactor were heated to 60° C. Then 3-aminopropyltrimethoxysilane, CAS No. 919-30-2, was added dropwise to the contents of the reactor with stirring. After the addition was complete, the ratio of amine functional groups to epoxy functional groups present in the reactor was 1:4 by weight. The stirring of the reactor contents was continued for 18-24 hours at 60° C. after the addition was completed; then the mixture was allowed to cool to room temperature. The cooled mixture is referred to below as the Functionalized Particulate.

An imidazoline-containing condensate of tall oil fatty acid with diethylene triamine (TOFA-DETA) including was combined with xylene to form a 50 wt % solution of TOFA-DETA in xylene (“Control 1”). An additional amount of TOFA-DETA was combined with xylene and then further with the Functionalized Particulate to form mixture having 50 wt % TOFA-DETA and 0.5 wt % Functionalized Particulate in xylene (“Example 1”).

A fatty acid-amine condensate salt having CAS No. 68910-85-0 was combined with xylene to form a 1 wt % solution of the fatty acid-amine condensate salt in xylene (“Control 2”). An additional amount of the fatty acid-amine condensate salt was combined with xylene and then further with the Functionalized Particulate to form mixture having 1 wt % of the fatty acid-amine condensate salt and 0.01 wt % Functionalized Particulate in xylene (“Example 2”).

Corrosion tests were performed using pre-weighed C1018 mild steel coupons (¼″×7⅜″) with sandblast finish. To make a test sample, a coupon is dipped for about 5 seconds in a Control mixture or an Example mixture, then removed; and excess liquid is allowed to drip from the coupon for about 10 seconds to result in a treated coupon. This treatment approximates batch treatment of coating materials applied in the field to the interior of pipes by pigging.

The treated coupon is immediately placed in a vessel containing a CO₂-saturated solution of 3% NaCl and the vessel is closed. The closed vessel is mounted on a wheel in a temperature-controlled cabinet set to a temperature of 60° C.; and the wheel is rotated at 26 rpm continuously for a first 24 hour period. After the first 24 hour period the rotating is stopped, and the CO₂-saturated 3% NaCl solution is replaced with fresh CO₂-saturated 3% NaCl, and the wheel is rotated for a second 24 hours period for a total of 48 hours of rotating. After the second 24 hour period the rotating is stopped, and the CO₂-saturated 3% NaCl solution is replaced with fresh CO₂-saturated 3% NaCl, and the wheel is rotated for a third 24 hour period for a total of 72 hours of rotating. After the third 24 hour period the rotating is stopped, and the CO₂-saturated 3% NaCl solution is replaced with fresh CO₂-saturated 3% NaCl, and the wheel is rotated for a fourth 24 hour period for a total of 96 hours of rotating. At the end of the 96 hour period, the coupons are removed from the vessel, cleaned and re-weighed and the corrosion rate in milli-inches per year (mpy) is determined by weight loss of the coupon.

The percentage of corrosion inhibition is determined by comparison to a Blank, that is, the foregoing test carried out on an untreated C1018 mild steel coupon.

The results of the corrosion inhibition test carried out on an untreated C1018 mild steel coupon (Blank) in addition to the Control 1, Example 1, Control 2, and Example 2 samples is shown in Table 1. Two coupons were separately tested in each case to ensure consistency and reproducibility of the test results.

TABLE 1
Corrosion inhibition test results obtained using
Example 1 and Example 2 treatment compositions,
Control compositions, or no treatment (Blank).

| | Corrosion | % |
|---|---|---|
| Treatment | Rate, mpy | Protection |
| None (Blank) | 17.98 | N/A |
| ″ | 17.10 | N/A |
| Control 1 | 12.34 | 30 |
| ″ | 11.84 | 32 |
| Example 1 | 4.96 | 72 |
| ″ | 5.87 | 67 |
| Control 2 | 9.47 | 46 |
| ″ | 9.59 | 45 |
| Example 2 | 4.71 | 73 |
| ″ | 4.38 | 75 |

The Example 1 coupons provided about 70% inhibition after 96 hours of continuous corrodent exposure, while the Control 1 coupons provided only about 31% protection after the same exposure. The Example 1 treatment provided more than twice the inhibition (that is, more than 100% greater inhibition) than the Control 1 treatment after 96 hours of continuous corrodent contact. Further, the Example 2 coupons provided about 74% inhibition after 96 hours of continuous corrodent exposure, while the Control 2 coupons provided only about 46% protection after the same exposure. The Example 2 treatment provided more than 50% greater inhibition than the Control 2 treatment after 96 hours of continuous corrodent contact.

What is claimed is:

1. A composition comprising a mixture of:
a corrosion inhibitor;
a particulate comprising silica and having an average particle size between 1 nm and 1000 nm, wherein the surface of the particulate comprises amine groups and epoxy groups; and
a solvent.

2. The composition of claim 1 wherein the mixture comprises 5 to 1000 parts by weight of the corrosion inhibitor for each part by weight of the particulate.

3. The composition of claim 1 wherein the mixture comprises 10 wt % to 90 wt % of the corrosion inhibitor.

4. The composition of claim 1 wherein the corrosion inhibitor comprises an amine group, or wherein the corrosion inhibitor comprises two or more amine groups, further wherein at least one of the amine groups is a primary amine group.

5. The composition of claim 1 wherein the corrosion inhibitor comprises an imidazoline, an amidoamine, a quaternary ammonium compound, an aromatic amine, an amine condensate, or a combination of two or more thereof,
wherein the imidazoline comprises a compound having the structure 1: 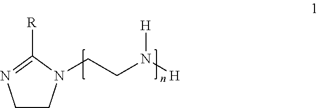
wherein R is a linear or branched alkyl, alkenyl, alkaryl, or aryl group having 12 to 30 carbons and n is an integer between 1 and 5;
wherein the amidoamine comprises a compound having structure 2: 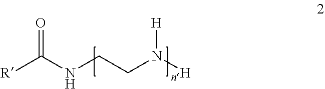
wherein R′ is a linear or branched alkyl, alkenyl, alkaryl, or aryl group having 12 to 30 carbons and n′ is an integer between 1 and 5;
wherein the quaternary ammonium compound comprises a C10-C20 alkyl dimethyl benzyl ammonium chloride, dodecyl didecyl dimethyl ammonium chloride, hexadecyltrimethylammonium chloride, benzalkonium chloride, or a combination of two or more thereof;
wherein the aromatic amine comprises a pyrimidine, a pyridine, a quinoline, a purine, an acridine, an amino-functionalized pyrimidine, pyridine, quinoline, purine, or acridine; a carboxyl-functionalized pyrimidine, pyridine, quinoline, purine, or acridine; a conjugate base of a carboxyl-functionalized pyrimidine, pyridine, quinoline, purine, or acridine; or a combination of two or more thereof; and
wherein the amine condensate is a reaction product of ethylene diamine, diethylene triamine, triethylenetetramine, tetraethylenepentamine, N-(2-aminoethyl)-1,2-ethanediamine, or a combination of two or more thereof; with a saturated fatty acid, a monounsaturated fatty acid, a polyunsaturated fatty acid, a tall oil fatty acid, or a combination of two or more thereof.

6. The composition of claim 1 wherein the particulate consists of silica.

7. The composition of claim 1 wherein an average particle size of the particulate is less than 300 nm.

8. The composition of claim 1 wherein the particulate surface is functionalized with a 3-glycidoxypropyl(trialkoxysilane) and a 3-aminopropyl(trialkoxysilane), optionally wherein the molar ratio of 3-glycidoxypropyl(trialkoxysilane) to 3-aminopropyl(trialkoxysilane) is between 1:10 and 100:1.

9. The composition of claim 1 wherein the solvent comprises xylene, benzene, toluene, aromatic naphtha, diesel, kerosene, fuel oil, or a combination of two or more thereof.

10. A coating disposed on a surface, the coating comprising a mixture of
a corrosion inhibitor; and
a particulate having an average particle size between 1 nm and 1000 nm, wherein the surface of the particulate comprises amine groups and epoxy groups.

11. The coating of claim 10 wherein the mixture comprises 5 to 1000 parts by weight of the corrosion inhibitor for each part by weight of the particulate.

12. The coating of claim 11 wherein the corrosion inhibitor comprises an amine group, or wherein the corrosion inhibitor comprises two or more amine groups, further wherein at least one of the amine groups is a primary amine group.

13. The coating of claim 12 wherein the corrosion inhibitor comprises an imidazoline, an amidoamine, a quaternary ammonium compound, an aromatic amine, an amine condensate, or a combination of two or more thereof;
wherein the imidazoline comprises a compound having the structure 1: 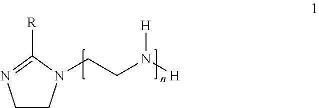
wherein R is a linear or branched alkyl, alkenyl, alkaryl, or aryl group having 12 to 30 carbons and n is an integer between 1 and 5;
wherein the amidoamine comprises a compound having structure 2: 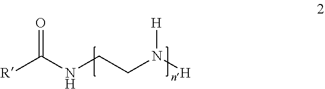
wherein R′ is a linear or branched alkyl, alkenyl, alkaryl, or aryl group having 12 to 30 carbons and n′ is an integer between 1 and 5;
wherein the quaternary ammonium compound comprises a C10-C20 alkyl dimethyl benzyl ammonium chloride, dodecyl didecyl dimethyl ammonium chloride, hexadecyltrimethylammonium chloride, benzalkonium chloride, or a combination of two or more thereof;
wherein the aromatic amine comprises a pyrimidine, a pyridine, a quinoline, a purine, an acridine, an amino-functionalized pyrimidine, pyridine, quinoline, purine, or acridine; a carboxyl-functionalized pyrimidine, pyridine, quinoline, purine, or acridine; a conjugate base of a carboxyl-functionalized pyrimidine, pyridine, quinoline, purine, or acridine; or a combination of two or more thereof; and
wherein the amine condensate is a reaction product of ethylene diamine, diethylene triamine, triethylenetetramine, tetraethylenepentamine, N-(2-aminoethyl)-1,2-ethanediamine, or a combination of two or more thereof; with a saturated fatty acid, a monounsaturated fatty acid, a polyunsaturated fatty acid, a tall oil fatty acid, or a combination of two or more thereof.

14. The coating of claim 12 wherein the coating comprises about 0.1 wt % to 10 wt % of the particulate, or about 1 wt % of the particulate.

15. The coating of claim 12 wherein the coating thickness is 1 μm to 1 mm.

16. The coating of claim 12 wherein the surface comprises metal, glass, or plastic, wherein the metal surface is a carbon steel surface, a steel alloy surface, a stainless steel surface, a copper alloy surface, a yellow metal surface, or a combination of two or more thereof.

17. The coating of claim 12 wherein the surface is an interior and/or exterior surface of a pipe, a tube, a containment, or a separator; and/or wherein the surface is located on a wellbore production string, on a water treatment facility, on a boiler, on a geothermal heat pump system, on a nuclear processing facility, on a water cooling tower, or a combination of two or more thereof.

18. A method of treating a surface, the method comprising:
forming a composition according to claim 1; and
contacting the composition with the surface to form a treated surface.

19. The method of claim 18 wherein the contacting is carried out in a batch treatment, wherein the batch treatment comprises dip coating, brush coating, spray coating, or pigging, optionally wherein the pigging is carried out by a smart pig, a spray pig, or a smart spray pig.

20. The method of claim 18 wherein contacting the treatment composition with the surface is applying a coating of the treatment composition to the surface, wherein the coating is applied at a thickness of 1 μm to 1 mm.

21. The method of claim 18 wherein the surface comprises metal, glass, plastic, or a combination of two or more thereof, wherein the metal surface is a carbon steel surface, a steel alloy surface, a stainless steel surface, a copper alloy surface, a yellow metal surface, or a combination of two or more thereof.

22. The method of claim 18 wherein the surface is an interior and/or exterior surface of a pipe, a tube, a containment, a separator, or a combination of two or more thereof; and/or wherein the surface is located on a wellbore production string, on a water treatment facility, on a boiler, on a geothermal heat pump system, on a nuclear processing facility, on a water cooling tower, or a combination of two or more thereof.

23. The method of claim 18 further comprising contacting the treated surface with a corrodent, wherein the corrodent is present in a crude oil, a produced water, or a combination thereof, and/or wherein the corrodent comprises H₂S.
